(19) United States
(12) Patent Application Publication
(10) Pub. No.: US 2024/0308695 A1
(43) Pub. Date: Sep. 19, 2024

(54) MONITORING SATELLITE, MONITORING SATELLITE SYSTEM, AND MONITORING METHOD

(71) Applicant: NEC Corporation, Tokyo (JP)

(72) Inventors: Yuya HOMMA, Tokyo (JP); Keisuke SATO, Tokyo (JP); Hironobu MORI, Tokyo (JP); Hideki KIMURA, Tokyo (JP)

(73) Assignee: NEC Corporation, Tokyo (JP)

(21) Appl. No.: 18/592,787

(22) Filed: Mar. 1, 2024

(30) Foreign Application Priority Data
Mar. 15, 2023 (JP) 2023-040392

(51) Int. Cl. B64G 1/10

(52) U.S. Cl. CPC B64G 1/1021; B64G 1/1007; B64G 1/1085

(57) ABSTRACT

A monitoring satellite system includes a space development agency (SDA) satellite investigating a threat object; and a monitoring satellite group including a plurality of monitoring satellites that orbit the Earth at intervals from each other and monitor flying objects, wherein each monitoring satellite monitors the flying object when at a location that allows monitoring of the flying object, and the monitoring satellite, upon discovering the threat object to the flying object while monitoring the flying object, transmits information about the threat object to the other monitoring satellites, the information about the threat object is a mission command that instructs the SDA satellite to investigate the threat object, and of the multiple monitoring satellites that transmit or receive the mission command, the monitoring satellite that is in a location that allows communication with the SDA satellite transmits the mission command to the SDA satellite.

### CROSS-REFERENCE TO RELATED APPLICATIONS

This application is based upon and claims the benefit of priority from Japanese patent application No. 2023-040392, filed on Mar. 15, 2023, the disclosure of which is incorporated herein in its entirety by reference.

### TECHNICAL FIELD

The present disclosure relates to a monitoring satellite, a monitoring satellite system, and a monitoring method.

### BACKGROUND ART

Satellites are used for Earth observation, positioning systems, and Internet communications. For example, PCT International Publication No. WO 2017-175696 (hereinbelow referred to as Patent Document 1) discloses a satellite system (satellite constellation) that can remotely manage multiple terminal devices (e.g., drones, automated vehicles) on Earth at any given time.

Geostationary satellites flying in geostationary Earth orbit (GEO), which is at an altitude of about 36,000 km from the Earth, are operated as meteorological and communication satellites because they can continuously observe specific locations on the Earth from the same direction. Space stations orbiting (about 400 km altitude) in low Earth orbit (LEO), which is at an altitude of less than 2,000 km from the Earth, are also operated for scientific research under conditions of microgravity and the space environment (e.g., the International Space Station (ISS)). In the following, these geostationary satellites and space stations will be collectively referred to as “flying objects”

There is concern about the presence of threat objects, which pose a threat to the operation of flying objects. A threat object is, for example, a satellite that attacks or interferes with communications with flying objects (called a “threat satellite”). Space debris that does not intentionally attack or interfere with communications but may approach and collide with an operational flying object is also considered a threat object. Space debris includes, for example, an out-of-service or malfunctioning satellite. With the rapid increase in the number of flying objects in operation, the number of threat objects is also expected to increase. There is an extremely high demand for rapid response (e.g., avoiding threat satellite attacks, capturing space debris) to threat objects that pose a threat to flight operations.

The example object of the present disclosure is to provide a monitoring satellite system, a monitoring satellite, a monitoring satellite monitoring method, and a program that enable prompt response to a threat object to a flying object.

### SUMMARY

According to the first example aspect of the disclosure, a monitoring satellite includes at least one memory configured to store instructions; and at least one processor configured to execute the instructions to: monitor a flying object; detect a threat object to the flying object; create a mission command which is information about the threat object when the threat object is detected; and transmit the mission command to a space development agency (SDA) satellite that investigates the threat object.

According to the second example aspect of the disclosure, a monitoring satellite system includes a space development agency (SDA) satellite investigating a threat object; and a monitoring satellite group including a plurality of monitoring satellites that orbit the Earth at intervals from each other and monitor a flying object, wherein each monitoring satellite monitors the flying object when at a location that allows monitoring of the flying object, and the monitoring satellite, upon discovering a threat object to the flying object while monitoring the flying object, transmits information about the threat object to the other monitoring satellites, the information about the threat object is a mission command that instructs the SDA satellite to investigate the threat object, and of the multiple monitoring satellites that transmit or receive the mission command, the monitoring satellite that is in a location that allows communication with the SDA satellite transmits the mission command to the SDA satellite.

According to the fourth example aspect of the disclosure, the monitoring method for controlling a monitoring satellite includes monitoring a flying object; detecting a threat object to the flying object; creating a mission command which is information about the threat object when the threat object is detected; and transmitting the mission command to a space development agency (SDA) satellite that investigates the thread object.

### Effects of the Disclosure

The present disclosure provides a monitoring satellite, a monitoring satellite group, a monitoring satellite system, a monitoring satellite monitoring method, and a program that enable rapid response to a threat object to a flying object.

### BRIEF DESCRIPTION OF THE DRAWINGS

FIG. 1 is a diagram showing the configuration of the monitoring satellite system according to the first example embodiment of the present disclosure.

FIG. 2 is a diagram showing the configuration of the SDA satellite for the first example embodiment of the present disclosure.

FIG. 3 is a diagram showing the configuration of a monitoring satellite according to the first example embodiment of the present disclosure.

FIG. 4A is a flow diagram of the monitoring satellite monitoring method according to the first example embodiment of the present disclosure.

FIG. 4B is a flow diagram of the monitoring satellite monitoring method according to the first example embodiment of the present disclosure.

FIG. 5 is a schematic diagram of a related monitoring satellite system.

FIG. 6 is a drawing that shows the minimum configuration of the monitoring satellite.

FIG. 7 is a drawing that shows the process flow of the monitoring satellite monitoring method with the minimum configuration.

### EXAMPLE EMBODIMENT

The following example embodiments of the present disclosure will be described using the drawings, but the following example embodiments do not limit the disclosure as claimed. Not all of the combinations of features described in the example embodiments are essential to the solution of the disclosure.

### First Example Embodiment

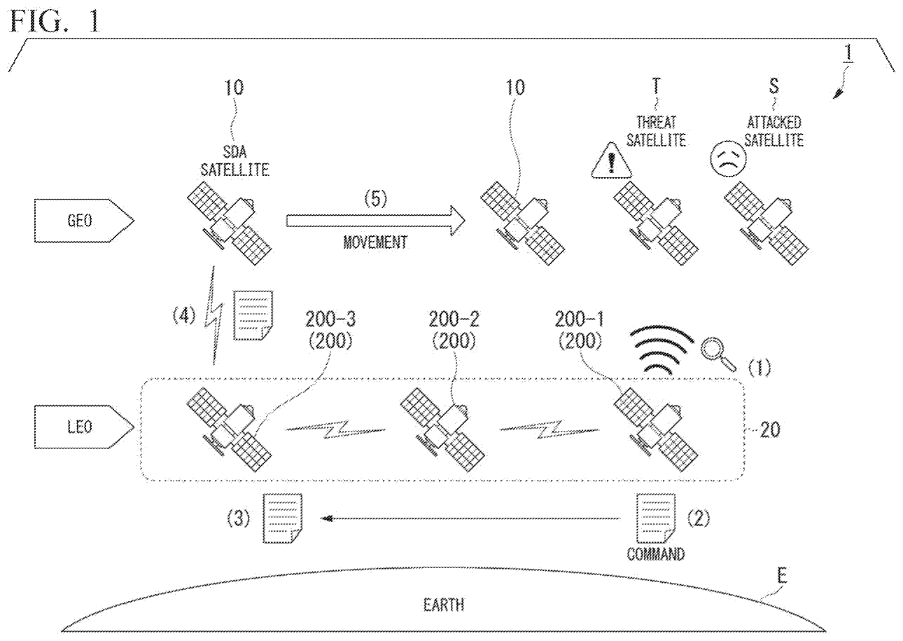

The first example embodiment of the present disclosure is described below with reference to FIGS. 1-5.

### <Monitoring Satellite System>

FIG. 1 shows the configuration of the monitoring satellite system according to the first example embodiment of the present disclosure. As shown in FIG. 1, a monitoring satellite system 1 is provided with an SDA satellite 10 and a monitoring satellite group 20. The SDA satellite 10 and the monitoring satellite group 20 fly in respective orbits around the Earth E. The monitoring satellite system 1 monitors threat objects T against flying objects S. In this system, the flying object S is a geostationary satellite. In the present example embodiment, the threat object T is a threat satellite approaching the flying object S.

### <SDA Satellite>

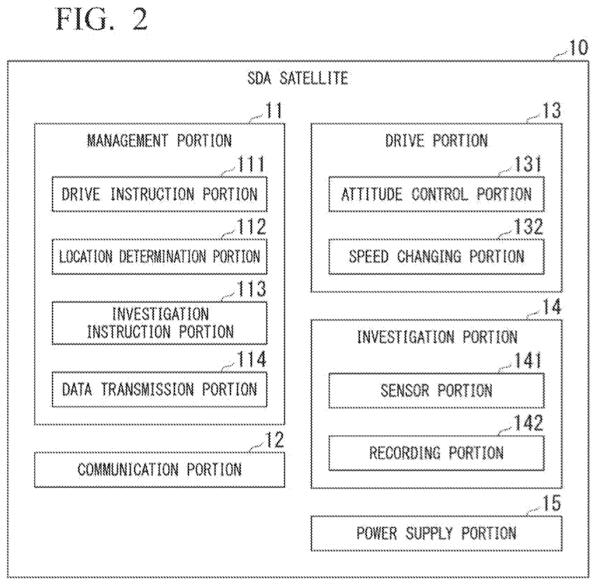

FIG. 2 shows the configuration of the SDA satellite. The SDA satellite 10 is provided with a management portion 11, a communication portion 12, a drive portion 13, an investigation portion 14, and a power supply portion 15. SDA stands for Space Domain Awareness.

When a threat object T is detected, the SDA satellite 10 receives information (hereinafter referred to as a “mission command”) including information indicating the fact that the threat object T has been detected (hereinafter referred to as “detection information”), predicted location information of the threat object T (hereinafter referred to as “predicted location information”), and information relating to instructions for an investigation to be executed on the threat object T (hereinafter referred to as “investigation instruction information”), moves so as to approach the thread object T and executes the investigation of the thread object T. The SDA satellite 10 investigates the threat object T for a period of time predetermined by the ground operator. The SDA satellite 10 can receive a mission command even while investigating a certain threat object T. After completing the investigation of one threat object T, the SDA satellite 10 determines the next threat object T to investigate based on the received mission command and executes the next investigation.

In this system, the SDA satellite 10 flies in a geostationary orbit (GEO) of the Earth E, just like a flying object (geostationary satellite) S, during normal times when no threat object T is detected.

The management portion 11 controls the operation of the drive portion 13 and the investigation portion 14 based on the mission command received from the communication portion 12. The management portion 11 is a computer. The management portion 11, for example, consists of a processor and memory of an on-board computer, but is not limited to this configuration and can use various computers, including known ones. The management portion 11 is equipped with a drive instruction portion 111, a location determination portion 112, an investigation instruction portion 113, and a data transmission portion 114.

After the SDA satellite 10 receives the mission command, the drive instruction portion 111 transmits an instruction to the drive portion 13 to perform a maneuver (movement of the SDA satellite 10) to approach the threat object T based on the predicted position information received. When the location determination portion 112 (described below) determines that the SDA satellite 10 has moved sufficiently close to the threat object T to perform the prescribed investigation, the drive instruction portion 111 transmits an instruction to the drive portion 13 to terminate the maneuver.

The location determination portion 112 determines whether the SDA satellite 10 has moved to the threat object T close enough to perform a given investigation.

The location determination portion 112, for example, has an image recording portion (not shown) and a threat object detection portion (not shown). The image recording portion records image data (e.g., visible light image data, thermographic data) in the vicinity of the SDA satellite 10 that is periodically acquired by a sensor 141 of the investigation portion 14 described below. The threat object detection portion compares the newly acquired image data with previously acquired image data to determine whether the threat object T has been detected in the image data. When the threat object T is detected in the image data, the location determination portion 112 determines that the SDA satellite 10 has moved close enough to the threat object T to perform a given investigation.

When the location determination portion 112 determines that the SDA satellite 10 has moved sufficiently close to the threat object T to perform the specified investigation, the investigation instruction portion 113 transmits an instruction to the investigation portion 14 to perform an investigation of the threat object T based on the received investigation instruction information.

The data transmission portion 114 transmits data concerning the results of the investigation performed by the investigation portion 14 (hereinafter referred to as “investigation data”) to the communication portion 12. The data transmission portion 114 transmits an instruction to the communication portion 12 to transmit the investigation data from the SDA satellite 10.

The communication portion 12 communicates with the monitoring satellite group 20. The communication portion 12 receives mission commands from the monitoring satellite group 20. The communication portion 12 transmits the investigation data to the monitoring satellite group 20. The communication portion 12 is provided with a microwave transmitter/receiver, for example, but is not limited to this configuration and can use various communication means, including known ones such as a transmitter/receiver of infrared laser light for communication.

The drive portion 13 performs a maneuver to approach the threat object T based on the predicted location information received. The drive portion 13 has an attitude control portion 131 and a speed changing portion 132.

The attitude control portion 131 controls the attitude of the SDA satellite 10. Various means, including gyro actuators, gyro sensors, hydrazine thrusters, ion thrusters, resist jet thrusters, and other known means, can be used for the control of the attitude performed by the attitude control portion 131.

The speed changing portion 132 changes the speed of the SDA satellite 10. Various means, including hydrazine thrusters, ion thrusters, resist jet thrusters, and other known means, can be used for changing of the speed performed by the speed changing portion 132.

Returning to FIG. 1, the speed changing portion 132 provides the SDA satellite 10 with the appropriate magnitude of propulsive force in the appropriate direction. For example, the speed changing portion 132 provides propulsion to the SDA satellite 10 so that the SDA satellite 10 transitions to a higher altitude orbit and flies to approach the threat object T and then transitions back to a geostationary satellite. This allows the geostationary SDA satellite 10 to move along its geostationary orbit as seen from the Earth (FIG. 1, (5)). As a result, the SDA satellite 10 can approach the threat object T.

Returning to FIG. 2, the investigation portion 14 executes the investigation of the threat object T based on the received investigation instruction information after the SDA satellite 10 has moved close enough to the threat object T to execute the prescribed investigation. The investigation portion 14 records the investigation data. The investigation portion 14 has a sensor portion 141 and a recording portion 142.

The sensor portion 141 acquires investigation data on the threat object T. The sensor portion 141 is equipped with, for example, an optical sensor (not shown) that acquires visible light image data, but is not limited to this configuration provided the sensor possesses resolution capable of discriminating between the threat object T and the flying object S, and can use various sensors, including known ones such as thermal infrared sensors, microwave sensors, SAR sensors, etc.

The recording portion 142 records the investigation data acquired by the sensor portion 141. The investigation data recorded by the recording portion 142 is transmitted to the communication portion 12 by the data transmission portion 114.

The power supply portion 15 provides power to the various parts of the SDA satellite 10. The power supply portion 15 is equipped with a solar cell, for example, but is not limited to this configuration and various means of supplying power, including known ones, can be used.

### <Monitoring Satellite Group>

Returning to FIG. 1, the monitoring satellite group 20 consists of a plurality of monitoring satellites 200 (200-1, 200-2, . . . 200-N in the case of N satellites). The plurality of monitoring satellites 200 that make up the monitoring satellite group 20 fly in an orbit at a lower altitude than the flying object S and the SDA satellite 10. The plurality of monitoring satellites 200 orbit the Earth at intervals from each other. The monitoring satellite group 20 is a satellite constellation that operates the multiple monitoring satellites 200-1, 200-2, . . . , 200-N as a single unit. In FIG. 1, only the three monitoring satellites 200-1, 200-2, and 200-3 are shown for clarity.

In the present example embodiment, the monitoring satellites 200-1, 200-2, . . . 200-N fly in low Earth orbit (LEO) of the Earth E.

The monitoring satellite group 20 monitors the flying object S (FIG. 1 (1)). When one monitoring satellite 200 (in FIG. 1, the monitoring satellite 200-1) of the monitoring satellite group 20 discovers a threat object T to the flying object S, the monitoring satellite 200 (monitoring satellite 200-1) calculates the coordinates of the threat object T and creates predictive location information. The monitoring satellite 200 (monitoring satellite 200-1) in question creates a mission command that includes the predictive position information (FIG. 1 (2)). The monitoring satellite 200 (monitoring satellite 200-1) transmits the mission command to the other monitoring satellites 200 (monitoring satellites 200-2 and 200-3 in FIG. 1). Among the monitoring satellite group 20, the monitoring satellite 200 (200-3 in FIG. 1) that is located near the SDA satellite 10 sends the mission command to the SDA satellite 10 (FIG. 1, (4)). This allows the SDA satellite 10 to begin moving along its geostationary orbit and approach the threat object T (FIG. 1, (5)).

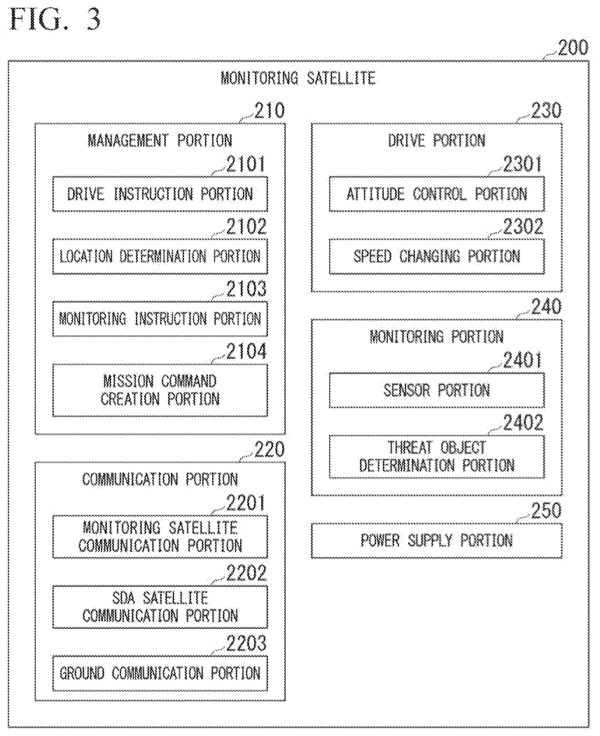

FIG. 3 shows the configuration of a monitoring satellite according to the first example embodiment of the present disclosure. The monitoring satellite 200 has a management portion 210, a communication portion 220, a drive portion 230, a monitoring portion 240, and a power supply portion 250.

The management portion 210 controls the operation of the drive portion 230 and the monitoring portion 240. The management portion 210 is a computer. The management portion 210 comprises, for example, an on-board computer processor and memory. The management portion 210 is equipped with a drive instruction portion 2101, a location determination portion 2102, a monitoring instruction portion 2103, and a mission command creation portion 2104.

The drive instruction portion 2101 transmits an instruction to the drive portion 230 so that the monitoring satellite 200 flies in an orbit spaced apart from the other monitoring satellites 200. This allows the plurality of monitoring satellites 200 to form a satellite constellation.

The location determination portion 2102 determines whether the monitoring satellite 200 is close enough to the flying object S to perform the prescribed monitoring. The location determination portion 2102 is equipped with, for example, a flight information recording portion (not shown). The location determination portion 2102 refers to the flight schedule of that monitoring satellite 200 recorded in the flight information recording portion to determine whether the monitoring satellite 200 is close enough to the flying object S to perform the prescribed monitoring.

The location determination portion 2102 determines whether the monitoring satellite 200 is close enough to the SDA satellite to transmit a mission command to the SDA satellite. The location determination portion 2102 is equipped with, for example, the aforementioned flight information recording portion. The location determination portion 2102 refers to the flight schedule of the monitoring satellite 200 recorded in the flight information recording portion to determine whether the monitoring satellite 200 is close enough to the SDA satellite to send a mission command to the SDA satellite.

The monitoring instruction portion 2103 transmits an instruction to the monitoring portion 240 to monitor the flying object S. The monitoring instruction portion 2103 transmits an instruction to the monitoring portion 240 to monitor the flying object S when the location determination portion 2102 has determined that the monitoring satellite 200 is sufficiently close to the flying object S to perform the prescribed monitoring.

The mission command creation portion 2104 creates the mission command and transmits it to the communication portion 220. In the monitoring satellite 200 that monitors the flying object S, if the monitoring portion 240 discovers the threat object T, the mission command creation portion 2104 calculates the coordinates of the threat object T and creates predictive location information. In the monitoring satellite 200 that discovers the threat object T, the mission command creation portion 2104 creates the mission command that includes detection information, predictive location information, and investigation instruction information. The mission command creation portion 2104 transmits the created mission command to the communication portion 220.

The communication portion 220 performs communication between that monitoring satellite 200 and other monitoring satellites 200 and the SDA satellite 10. The communication portion 220 is equipped with a monitoring satellite communication portion 2201, an SDA satellite communication portion 2202, and a ground communication portion 2203. The monitoring satellite communication portion 2201, the SDA satellite communication portion 2202, and the ground communication portion 2203 are provided with a microwave transmitter/receiver, for example, but are not limited to this configuration and can use various communication means, including known ones such as a transmitter/receiver of infrared laser light for communication.

The monitoring satellite communication portion 2201 provides communication between the monitoring satellite 200 and other monitoring satellites 200. The monitoring satellite communication portion 2201 receives the mission command created by the mission command creation portion 2104 in that monitoring satellite 200 and transmits it to the other monitoring satellites 200. The monitoring satellite communication portion 2201 receives mission commands from the other monitoring satellites 200. This allows all the monitoring satellites 200 that make up the monitoring satellite group 20 to share mission commands that include detection information.

In the transmission of information from one monitoring satellite 200 to all other monitoring satellites 200, for example, first the information is transmitted from that one monitoring satellite 200 to the monitoring satellites 200 flying adjacent to that monitoring satellite 200. Next, the monitoring satellites 200 that have received the information transmit the information to the monitoring satellites 200 flying adjacent to the monitoring satellites 200 that have not yet received the information. By repeating this process, all the monitoring satellites 200 that make up the monitoring satellite group 20 can share information.

The monitoring satellite communication portion 2201 transmits a mission command transmission completion notification to the other monitoring satellites 200 after that monitoring satellite 200 has transmitted a mission command to the SDA satellite 10. The monitoring satellite communication portion 2201 receives mission command transmission completion notifications from the other monitoring satellites 200.

The SDA satellite communication portion 2202 performs communication between the monitoring satellite 200 and the SDA satellite 10. The SDA satellite communication portion 2202 transmits the mission command to the SDA satellite 10. The SDA satellite communication portion 2202 transmits the mission command to the SDA satellite 10 when the location determination portion 2102 has determined that the monitoring satellite 200 is sufficiently close to the SDA satellite to transmit the mission command to the SDA satellite.

The ground communication portion 2203 performs communication between the monitoring satellite 200 and a ground station (not shown) on Earth E. The ground communication portion 2203, for example, transmits (uplinks) information about control to form a satellite constellation from the ground station to the monitoring satellite 200. The ground communication portion 2203, for example, transmits (downlinks) detection information of the threat object T from the monitoring satellite 200 to the ground station.

The drive portion 230 drives the monitoring satellite 200 so that it flies in orbit in synchronization with the other monitoring satellites 200. The drive portion 230 has an attitude control portion 2301 and a speed changing portion 2302.

The attitude control portion 2301 controls the attitude of the monitoring satellite 200. Various means, including gyro actuators, gyro sensors, hydrazine thrusters, ion thrusters, resist jet thrusters, and other known means, can be used for the control of the attitude performed by the attitude control portion 2301.

The speed changing portion 2302 changes the speed of the monitoring satellite 200. Various means, including hydrazine thrusters, ion thrusters, resist jet thrusters, and other known means, can be used for changing of the speed performed by the speed changing portion 2302.

The monitoring portion 240 performs monitoring of the flying object S when its monitoring satellite 200 is close enough to the flying object S to perform the prescribed monitoring. The monitoring portion 240 records monitoring data. The monitoring portion 240 is equipped with a sensor portion 2401 and a threat object determination portion 2402.

The sensor portion 2401 acquires data concerning the results of the monitoring of the flying object S (“monitoring data”). The sensor portion 2401 is equipped with, for example, an optical sensor (not shown) that acquires visible light image data, but is not limited to this configuration provided the sensor possesses resolution capable of discriminating between the threat object T and the flying object S, and can use various sensors, including known ones such as thermal infrared sensors, microwave sensors, SAR sensors, etc.

The threat object determination portion 2402 determines whether or not the threat object T has approached the flying object S based on the monitoring data acquired by the sensor portion 2401. When the threat object determination portion 2402 determines that the threat object T has approached the flying object S, the mission command creation portion 2104 creates a mission command.

The threat object determination portion 2402, for example, has an image data recording portion (not shown) and a threat object detection portion (not shown). The image data recording portion records image data (e.g., visible light image data, thermographic data) of the flying object S that is periodically acquired by the sensor portion 2401. The threat object detection portion compares the newly acquired image data with previously acquired image data to determine whether the threat object T has been detected in the image data. When the threat object T is detected in the image data, the threat object determination portion 2402 determines that the threat object T has approached the flying object S.

The power supply portion 250 provides power to the various parts of the monitoring satellite 200. The power supply portion 250 is equipped with a solar cell, for example, but is not limited to this configuration and various means of supplying power, including known ones, can be used.

### <Monitoring Satellite Monitoring Method>

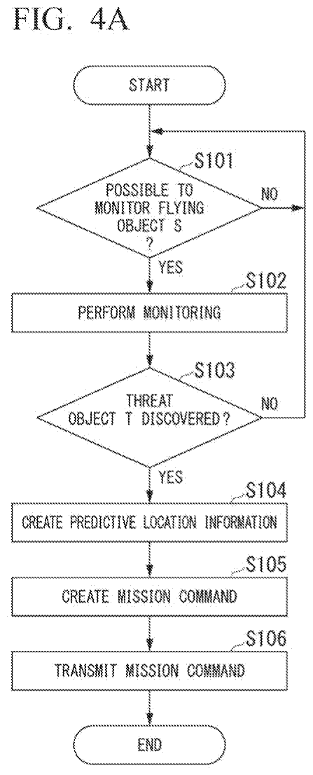

FIGS. 4A and 4B below describe the monitoring satellite monitoring method according to the first example embodiment of the present disclosure.

FIG. 4A is a flow diagram of the monitoring satellite monitoring method of the first example embodiment of the present disclosure, leading up to the transmission of a mission command to another monitoring satellite.

First, the monitoring satellite 200 (see FIG. 1) determines whether it is close enough to the flying object S for itself to perform the prescribed monitoring (S101).

If the monitoring satellite 200 is sufficiently close to the flying object S (S101: YES), the monitoring satellite 200 performs monitoring of the flying object S (S102). On the other hand, if the monitoring satellite 200 has not sufficiently approached the flying object S (S101: NO), the system returns to Step S101 and repeats the determination of whether or not it has approached the flying object S.

When the monitoring satellite 200 performs monitoring of the flying object S and finds the threat object T (S103: YES), the monitoring satellite 200 creates predictive location information for the threat object T (S104). On the other hand, if no threat object T is found (S101: NO), the process returns to Step S101 and the determination of whether the monitoring satellite has approached the flying object S is repeated.

After Step S104, the monitoring satellite 200 creates a mission command that includes the predictive location information of the threat object T (S105). The monitoring satellite 200 then transmits the created mission command to the other monitoring satellites 200 (S106).

FIG. 4B is a flow diagram of the monitoring satellite monitoring method according to the first example embodiment of the present disclosure, from transmission/reception of mission commands between monitoring satellites to transmission of a mission command to the SDA satellite 10.

After the mission command has been transmitted and received between the monitoring satellites 200, the monitoring satellite 200 determines whether it is close enough to the SDA satellite 10 to transmit the mission command to the SDA satellite 10 (S201).

If the monitoring satellite 200 is close enough to the SDA satellite 10 (S201: YES), the monitoring satellite 200 transmits a mission command to the SDA satellite 10 (S202). The monitoring satellite 200 then transmits a mission command transmission completion notification to the other monitoring satellites 200 (S203).

On the other hand, if the monitoring satellite 200 is not close enough to the SDA satellite 10 (S201: NO), the monitoring satellite 200 determines whether it has received a mission command transmission completion notification (S204). When it has been received (S204: YES), the procedure is terminated. When it has not been received (S204: NO), the process returns to Step S201, and the monitoring satellite 200 repeats the determination of whether or not it has approached the SDA satellite 10.

The above monitoring method allows the monitoring satellite 200 that is in a position to monitor the flying object S to perform monitoring of the flying object S. When the monitoring satellite 200 that monitors the flying object S discovers a threat object T, it can create a mission command that includes predictive location information and share the mission command with other monitoring satellites 200. When the monitoring satellite 200 that has shared the mission command is in a position to communicate with the SDA satellite 10, it can transmit the mission command to the SDA satellite 10. This allows the SDA satellite 10 to receive the mission command, approach the threat object T, and perform an investigation of the threat object T.

The processing performed by the monitoring satellite system 1 is stored in the form of a computer-readable program on a recording medium (not shown) provided by the monitoring satellite system 1. When this program is read and executed by a computer, processing is performed in the monitoring satellite system 1. For example, the program for the process of processing performed by an individual monitoring satellite 200 may be stored on a storage medium provided by that monitoring satellite 200 or on another storage medium external to that monitoring satellite 200.

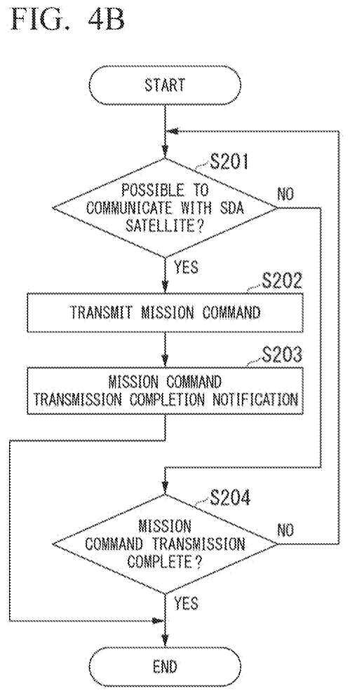

FIG. 5 shows a schematic of the associated monitoring satellite system. In the monitoring satellite system shown in FIG. 5, unlike the current system, monitoring of flying objects (attacked satellites) and detection of threat objects (threat satellites) are performed using ground antennas rather than monitoring satellites (FIG. 5(1)). In the monitoring satellite system shown in FIG. 5, unlike the present example embodiment, mission commands to the SDA satellite are not transmitted by the monitoring satellite but by a ground station that receives commands from the ground antenna (FIGS. 5(2) and 5(3)).

In the monitoring satellite system shown in FIG. 5, ground antennas are used to monitor flying objects (detection of threat objects). Therefore, the range of being able to monitor flying objects (being able to detect threat objects) is limited to the area covered by the ground antenna. If the flying object is a geostationary satellite, since the flying object is always located in a certain direction from the ground antenna, if the flying object is located in a direction that can be observed from the ground antenna, it will not move to a position that cannot be observed from the ground antenna as it orbits the Earth, but the ground antenna may not be able to observe the flying object due to the environment on the Earth (e.g., weather).

In the monitoring satellite system shown in FIG. 5, when initiating an investigation of a threat object, a mission command must be uplinked from the ground station to the SDA satellite. Therefore, the SDA satellite must wait for a timing when the ground station can communicate with the SDA satellite in order to begin investigating the threat object. If the SDA satellite is a geostationary satellite, since the SDA satellite is always located in a certain direction from the ground station, if the SDA satellite is located in a direction that allows communication from the ground station, the SDA satellite will not move to a position where it cannot communicate with the ground station as it orbits the Earth, however, it is possible that the ground station and the SDA satellite may lose communication due to the Earth's environment (e.g., weather).

According to the present example embodiment, the monitoring satellite is flying in low Earth orbit (LEO). Compared to a ground-based antenna, this reduces the risk that the monitoring of flying objects (detection of threat objects) will be compromised by the effects of the environment on Earth. As a result, the present example embodiment is effective in quickly detecting threat objects.

According to the present example embodiment, the monitoring satellite orbits the Earth. This enables monitoring of flying objects (detection of threat objects) even when flying objects (threat objects) are located in positions that cannot be observed from antennas on the ground. As a result, the present example embodiment is effective in detecting threat objects more quickly.

According to the present example embodiment, the monitoring satellite is flying in low Earth orbit (LEO). Compared to a ground station, this reduces the risk of communication failure with the SDA satellite due to the influence of the environment on Earth. As a result, the present example embodiment is effective in transmitting commands to the SDA satellite more quickly.

According to the present example embodiment, the monitoring satellite orbits the Earth. This allows communication with the SDA satellite even when the SDA satellite is located in a position where communication is not possible from the ground station. As a result, the present example embodiment is effective in transmitting commands to the SDA satellite more quickly.

As described above, the present example embodiment exhibits the effect of enabling the rapid detection of threat objects and the more rapid transmission of commands to the SDA satellite. As a result, the present example embodiment is effective in increasing the opportunities to investigate threat objects by reducing the time required from the discovery of the threat object to the start of investigation by the SDA satellite.

The present example embodiment reduces the opportunity for ground facilities (ground antennas and ground stations) to be in operation. As a result, the present example embodiment has the effect of reducing the cost of maintenance and usage fees for ground facilities.

### Second Example Embodiment

The second example embodiment of the present disclosure is described below. Those constituent elements in common with the first example embodiment are omitted from the description.

A monitoring satellite 200 (monitoring satellite group 20) according to the present example embodiment is characterized by having a large data storage capacity for recording monitoring data of flying objects S or investigation data of threat objects T. The large data storage capacity may be provided in each of the monitoring satellites 200 that make up the monitoring satellite group 20, or in some of the monitoring satellites 200 within the monitoring satellite group 20. Recordings of monitoring or investigation data may be distributed and recorded on multiple monitoring satellites 200 equipped with high-capacity data storage. The monitoring satellite 200 (group of monitoring satellite group 20) may be equipped with computing functions (cloud computing functions) to process monitoring and investigation data, as well as large data storage.

To use the monitoring data of a flying object S acquired by the monitoring satellite 200 (monitoring satellite group 20) at a ground station, it is necessary to transmit (downlink) the monitoring data from the monitoring satellite 200 (monitoring satellite group 20) to the ground station. When using the investigation data of the threat object T acquired by the SDA satellite 10 at the ground station, it is necessary to transmit (downlink) the monitoring data received from the SDA satellite 10 from the monitoring satellite 200 (monitoring satellite group 20) to the ground station after transmitting the investigation data from the SDA satellite 10 to the monitoring satellite 200 (monitoring satellite group 20).

If the capacity of the data storage media provided by the monitoring satellite 200 (monitoring satellite group 20) is small, each time a certain amount of monitoring data is acquired or a certain amount of investigation data is received, a process of overwriting and deleting the monitoring data or investigation data or a process of downlinking the monitoring data or investigation data must be performed. In contrast, because the present example embodiment is provided with a large-capacity data storage, the number of processes to overwrite and erase the monitoring data or investigation data or the number of processes to downlink the monitoring data or investigation data can be reduced.

### Third Example Embodiment

The third example embodiment of the present disclosure is described below. Those constituent elements in common with the first example embodiment are omitted from the description.

The monitoring satellite 200 (monitoring satellite group 20) is equipped with an algorithm to determine whether or not the threat object T is attacking the flying object S or interfering with communication with the flying object S based on the acquired monitoring data. The algorithm is stored in the form of a computer-readable program on a storage medium (not shown) provided by the monitoring satellite 200.

If the algorithm determines that the threat object T is attacking or disrupting communications, the monitoring satellite 200 transmits the results of its determination to the other monitoring satellites 200. The monitoring satellite 200 that is in a position to communicate with the SDA satellite 10 transmits the results of the algorithm determination to the SDA satellite 10 along with the mission command.

According to the present example embodiment, since the SDA satellite 10 has more information to make decisions when deciding on the next investigation target, it is possible to conduct more effective investigations.

### Fourth Example Embodiment

The fourth example embodiment of the present disclosure is described below. Those constituent elements in common with the first example embodiment are omitted from the description.

The monitoring satellite 200 (monitoring satellite group 20) is equipped with a removal portion that removes the threat object T. The removal portion is equipped with a robotic hand to remove the threat object T from its orbit, for example, by capturing the threat object T or by impacting the threat object T. The removal portion is equipped with a laser device, for example, to remove the threat object T from its orbit by irradiating the threat object T with a laser beam.

According to the present example embodiment, the SDA satellite 10 can process the threat object T in addition to monitoring the threat object T. As a result, it is possible to more quickly respond to an attack or communication interference from a threat object T.

The above is an example of suitable example embodiments of the disclosure with reference to the accompanying drawings, but it goes without saying that the disclosure is not limited to such examples. The shapes and combinations of the components shown in the above examples are merely examples, and can be changed in various ways based on design requirements to the extent that they do not deviate from the main purpose of the disclosure.

For example, in the first example embodiment of the present disclosure, the sensor portion 2401 of the monitoring satellite 200 acquired monitoring data of the flying object S, but in addition to monitoring data, it may also capture images of the Earth. This allows the monitoring satellite group 20 group to be used for remote sensing of the Earth in addition to monitoring flying objects S.

For example, in the first example embodiment of the present disclosure, there was one SDA satellite 10, but there may be multiple SDA satellites 10. This allows the SDA satellite 10 closest to the threat object T to perform the investigation. As a result, the threat object T can be dealt with more quickly.

For example, in the first example embodiment of the present disclosure, the monitoring satellite 200 (monitoring satellite group 20) flew in low Earth orbit (LEO), but it may fly in orbits other than LEO, at a lower altitude than the flying object S or SDA satellite 10. For example, the monitoring satellite 200 (monitoring satellite group 20) may fly in medium Earth orbit (MEO).

For example, in the first example embodiment of the present disclosure, the flying object S and SDA satellite 10 were flying in a geostationary orbit, but they may be flying in a non-geostationary orbit at a higher altitude than the monitoring satellite 200 (monitoring satellite group 20). For example, the flying object S may be flying in a quasi-zenith orbit. For example, the flying object S may be a space station (altitude about 400 km). Compared to a geostationary satellite, the flying object S may move to a position that is unobservable from ground antennas or unreachable from ground stations due to the orbit of the flying object S around the Earth. Even in these cases, the present disclosure enables monitoring of flying objects (detection of threat objects) and communication with SDA satellites. Thus, the present disclosure is effective in detecting threat objects more quickly and in transmitting commands to SDA satellites more quickly.

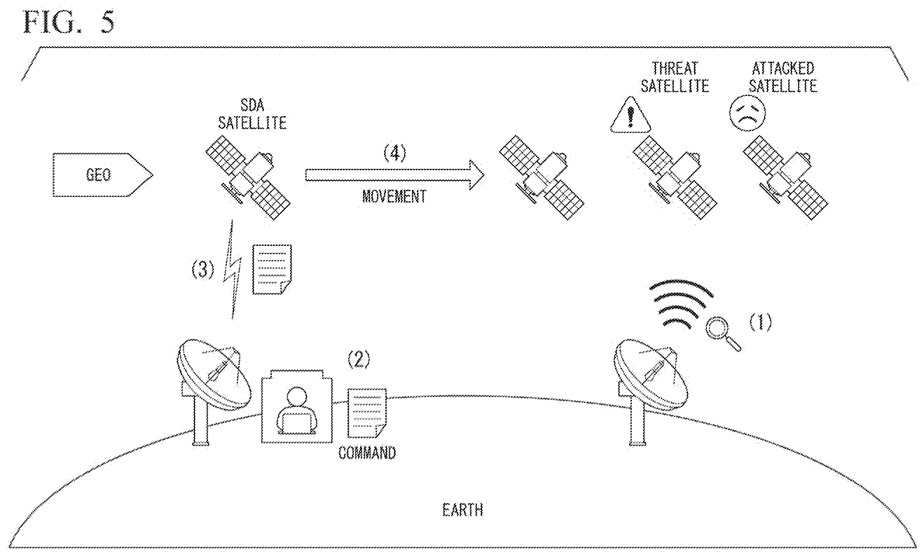

For example, in the first example embodiment of the present disclosure, the monitoring satellite 200 (monitoring satellite group 20) and the SDA satellite 10 flew in Earth's orbit, but they may also fly in the orbit of other celestial bodies such as the moon. FIG. 6 is a drawing that shows the minimum configuration of the monitoring satellite.

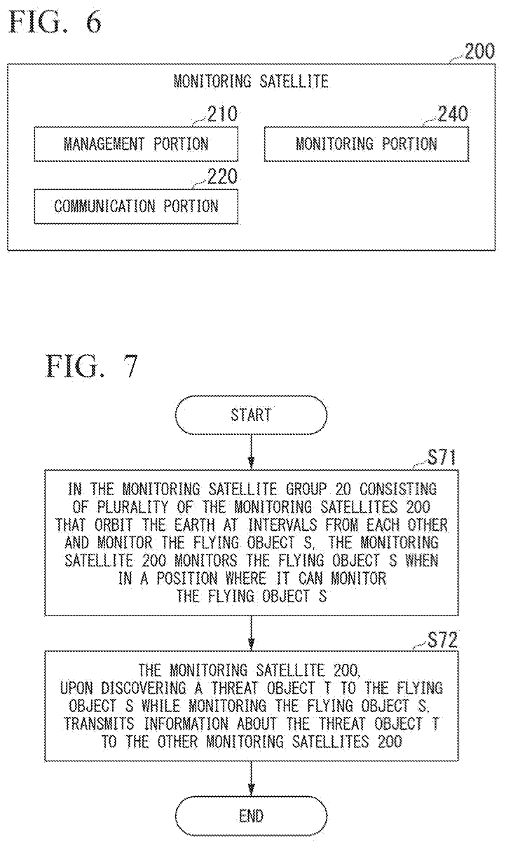

FIG. 7 is a diagram that shows the process flow of the monitoring satellite monitoring method with the minimum configuration.

The monitoring satellite 200 is equipped with at least the management portion 210, the communication portion 220, and the monitoring portion 240 that monitors the flying object to detect the threat object. The functions of each of these processing portions are implemented in the computer of the monitoring satellite 200. The functions of each of these processing portions may be implemented by circuitry in the monitoring satellite 200, or they may be implemented in the monitoring satellite 200 by a CPU or other processing unit executing the above program.

In the monitoring satellite group 20 consisting of a plurality of the monitoring satellites 200 that orbit the Earth at intervals from each other and monitor the flying object S, the monitoring satellite 200 monitors the flying object S when it is in a position where it can monitor the flying object S (Step S71).

The monitoring satellite 200, upon discovering a threat object T to the flying object S while monitoring the flying object S, transmits information about the threat object T to the other monitoring satellites 200 (Step S72).

Some or all of the above example embodiments may also be described as, but not limited to, the following Supplementary Notes.

(Supplementary Note 1) A monitoring satellite provided with a management portion, a communication portion, and a monitoring portion that monitors a flying object to detect a threat object to the flying object, wherein the management portion includes a monitoring instruction portion that transmits an instruction to the monitoring portion to monitor the flying object, and a mission command creation portion that, when the monitoring portion detects the threat object, creates a mission command, which is information about the threat object, and the communication portion transmits the mission command to an SDA satellite that investigates the threat object.

(Supplementary Note 2) The monitoring satellite according to Supplementary Note 1, wherein the management portion includes a location determination portion that makes a determination regarding the location of the monitoring satellite, and the communication portion transmits the mission command to the SDA satellite from the monitoring satellite which the location determination portion has determined is in a location capable of communicating with the SDA satellite.

(Supplementary Note 3) A monitoring satellite provided with a management portion, a communication portion, and a monitoring portion that monitors a flying object to detect a threat object to the flying object, wherein the management portion includes a monitoring instruction portion that transmits an instruction to the monitoring portion to monitor the flying object, and a mission command creation portion that, when the monitoring portion detects the threat object, creates a mission command, which is information about the threat object, and the communication portion transmits the mission command to another monitoring satellite from the monitoring satellite that created the mission command.

(Supplementary Note 4) A monitoring satellite provided with a management portion, a communication portion, and a monitoring portion that monitors a flying object to detect a threat object to the flying object, wherein the management portion includes a location determination portion that makes a determination regarding the location of the monitoring satellite and a monitoring instruction portion that transmits an instruction to the monitoring portion to monitor the flying object, and the monitoring instruction portion transmits an instruction to the monitoring portion to monitor the flying object when the location determination portion has determined that the monitoring satellite is in a location capable of monitoring the flying object.

(Supplementary Note 5) The monitoring satellite according to any one of supplementary notes 1 to 4, provided with a drive portion that flies the monitoring satellite, wherein the management portion includes a drive instruction portion that transmits an instruction to the drive portion to fly an orbit spaced apart from other monitoring satellites.

(Supplementary Note 6) The monitoring satellite according to any of supplementary notes 1 to 4, provided with a high-capacity data storage.

(Supplementary Note 7) The monitoring satellite according to any of supplementary notes 1 to 4, provided with an algorithm that determines whether or not the threat object is attacking the flying object or interfering with communications with the flying object based on data acquired by the monitoring portion.

While preferred example embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

What is claimed is:

1. A monitoring satellite comprising:
at least one memory configured to store instructions; and
at least one processor configured to execute the instructions to:
monitor a flying object;
detect a threat object to the flying object;
create a mission command which is information about the threat object when the threat object is detected; and
transmit the mission command to a space development agency (SDA) satellite that investigates the thread object.

2. The monitoring satellite according to claim 1, wherein the at least one processor is configured to execute the instructions to:
determine a location of the monitoring satellite; and
transmit the mission command to the SDA satellite from the monitoring satellite which the determined location is in a location capable of communicating with the SDA satellite.

3. The monitoring satellite according to claim 1, wherein the at least one processor is configured to execute the instructions to transmit the mission command to another monitoring satellite.

4. The monitoring satellite according to claim 1, wherein the at least one processor is configured to execute the instructions to:
determine a location of the monitoring satellite; and
transmit an instruction to monitor the flying object when the determined location that the monitoring satellite is in a location capable of monitoring the flying object.

5. The monitoring satellite according to claim 1, wherein the at least one processor is configured to execute the instructions to fly the monitoring satellite; and
transmit an instruction to fly an orbit spaced apart from other monitoring satellites.

6. The monitoring satellite according to claim 1, further comprising a high-capacity data storage.

7. The monitoring satellite according to claim 1, wherein the at least one processor is configured to execute the instructions to determine whether or not the threat object is attacking the flying object or interfering with communications with the flying object based on acquired data.

8. A monitoring satellite system comprising:
a space development agency (SDA) satellite investigating a threat object; and
a monitoring satellite group including a plurality of monitoring satellites that orbit the Earth at intervals from each other and monitor flying objects,
wherein each monitoring satellite monitors the flying object when at a location that allows monitoring of the flying object, and
the monitoring satellite, upon discovering the threat object to the flying object while monitoring the flying object, transmits information about the threat object to the other monitoring satellites,
the information about the threat object is a mission command that instructs the SDA satellite to investigate the threat object, and
of the multiple monitoring satellites that transmit or receive the mission command, the monitoring satellite that is in a location that allows communication with the SDA satellite transmits the mission command to the SDA satellite.

9. The monitoring satellite system according to claim 8, wherein the monitoring satellites fly in low Earth orbit.

10. A monitoring method for controlling a monitoring satellite comprising:
monitoring a flying object;
detecting a threat object to the flying object;
creating a mission command which is information about the threat object when the threat object is detected; and
transmitting the mission command to a space development agency (SDA) satellite that investigates the thread object.

11. The monitoring method according to claim 10, further comprising:
determining a location of the monitoring satellite; and
transmitting the mission command to the SDA satellite from the monitoring satellite which the determined location is in a location capable of communicating with the SDA satellite.

12. The monitoring method according to claim 10, further comprising transmitting the mission command to another monitoring satellite.

13. The monitoring method according to claim 10, further comprising:
determining a location of the monitoring satellite; and
transmitting an instruction to monitor the flying object when the determined location that the monitoring satellite is in a location capable of monitoring the flying object.

14. The monitoring method according to claim 10, further comprising:
flying the monitoring satellite; and
transmitting an instruction to fly an orbit spaced apart from other monitoring satellites.

15. The monitoring method according to claim 10, further comprising determining whether or not the threat object is attacking the flying object or interfering with communications with the flying object based on acquired data.
